(19) United States
(12) Patent Application Publication
(10) Pub. No.: US 2020/0195096 A1
(43) Pub. Date: Jun. 18, 2020

(54) REDUNDANT ELECTRICAL MACHINE FOR DRIVING A MEANS OF PROPULSION

(71) Applicant: SIEMENS AKTIENGESELLSCHAFT, München (DE)

(72) Inventors: Christian LOESCH, Erlangen (DE); Markus SONS, Nuernberg (DE)

(21) Appl. No.: 16/618,687

(22) PCT Filed: May 29, 2018
(86) PCT No.: PCT/EP2018/064002

§ 371 Date: Dec. 2, 2019

(30) Foreign Application Priority Data
May 31, 2017 (DE) 10 2017 209 174.6

(51) Int. Cl. H02K 11/30; H02K 1/12; H02K 1/22; H02K 3/47

(52) U.S. Cl. CPC H02K 11/30; H02K 3/47; H02K 1/22; H02K 1/12

(57) ABSTRACT

The invention relates to an in particular redundant electrical machine for driving a propulsion means with improved protection against failure. The machine includes for example two submachines consisting in each case of a stator winding system and a rotor, wherein the two rotors are arranged on a common shaft in a rotationally fixed manner, by way of which shaft the propulsion means is ultimately set in motion. Also provided is a movement device which has the effect, in the case of a fault in one of the stator winding systems, that the air gap between the stator winding system in question and the associated rotor is increased for the corresponding faulty submachine such that the electromagnetic interaction between these components is suppressed.

The invention relates to an in particular redundant electrical machine for driving a propulsion means with improved protection against failure.

In electrical machines, the insulation of the stator winding system of the machine may fail due to material or manufacturing defects that are not identified or are not able to be identified, as well as in the case of operational overloads, such as for example caused by voltage and/or current spikes. Such cases of faults may arise for example when a shorted coil, a winding short circuit or a ground short circuit occurs in the stator winding system. Such failure causes a functional failure as the damage propagates and, in the worst-case scenario, causes the electrical machine to catch fire.

Such a development in principle constitutes a hazardous situation since it results at least in failure of and possibly damage to the machine, which may have more or less severe consequences depending on how the machine is used. In particular in the case of using the electrical machine as part of the drive system of an electrically or hybrid-electrically driven aircraft, the failure of the electrical machine may have fatal consequences. Components or systems used in aviation accordingly have to have sufficient protection against failure.

In order to reduce the probability of failure or to improve protection against failure, electrical machines for use in aircraft drives usually have a redundant design, such that failure of a subsystem of the drive does not lead to failure of the entire drive system and to the downfall of the entire aircraft. Redundancy may be achieved by duplicating a complete drivetrain, that is to say providing two propellers including the corresponding motors, or else by increasing the redundancy of components with an increased probability of failure, that is to say a motor having for example two winding systems and accordingly two voltage sources in addition to respective power electronics systems is connected upstream of a propeller. Complete redundancy of all of the components generally leads to a considerably higher space and cost outlay for the drivetrain, for which reason it is sought to distribute the redundancy to particular components.

In the case of an electric motor having two winding systems, said electric motor may continue to be operated, even if only to a restricted extent, in the event of failure of one of the two power electronics systems in the normal case. If there is however a failure within the permanent magnet-excited motor, for example a shorted coil, a phase short circuit or another short circuit, this fault site is still coupled to the magnetic circuit and the rotating rotor induces a voltage in the faulty winding system that, due to the short circuit, drives a typically very high fault current that may lead to great overheating of the machine as far as catching fire. Due to the permanent-magnet excitation, this is not easily able to be switched off, as would be the case for example with an electrically excited machine. Redundancy is then no longer provided by the two or more winding systems. A fault may even propagate to the adjacent winding system. If the two winding systems are on the same circumference, each system for example in each case in a half shell, a fault in one winding system may also continue to the second winding system. A further problem is an effect known as “windmilling” in which the propeller will continue to rotate the rotor during flight even when the faulty drivetrain has been switched off, and an induced fault current will thereby continue to flow.

EP2896532A1 achieves redundancy using two stator winding systems for safety reasons, as already indicated above, wherein a dedicated voltage source is provided for each of the two winding systems. The two separate winding systems interact with only one rotor that is equipped with permanent magnets. If a fault is detected in one of the two winding systems or in one of the two voltage sources, for example an excess temperature, an overvoltage or an overcurrent, deactivation of the faulty winding system or of the faulty voltage source is triggered by disconnecting the associated voltage source, whereas the second winding system is able to continue to be operated as normal.

Although the described redundant system allows continued operation, it is not in principle able to be ruled out that an electric current continues to flow through the faulty winding system, which may lead to overheating of the machine. A source of such a current flow may be firstly the actual current source that supplies the stator winding system as normal. This may and consequently must be switched off immediately when a case of a fault is identified. In addition, however, the currents that are induced in the winding system due to the ongoing rotation of the motor rotor with respect to the faulty stator winding system also need to be taken into account, these currents occurring in particular in permanently excited electrical machines. Due to the associated fire hazard, hazardous overheating therefore has to be prevented immediately after detecting the fault by securely interrupting this current flow, which promotes the propagation of damage, in the winding system.

In such safety-critical systems, in the case of a fault, for example in the case of a short circuit in the stator winding system, secure switching-off must thus be possible in the electrical machine. If the rotor assigned to the faulty stator winding system or interacting electromagnetically therewith, as described above, continues to be rotated by external influences, for example by a propeller or, as in EP2896532A1, by a further electrical machine in the same mechanical chain, power is still induced in the faulty winding system by the rotor equipped with permanent magnets. As mentioned, this may lead to a fire and thus compromise safety. In order to prevent this, the requirement would necessarily arise to switch off or to stop the complete chain, as a result of which the desired redundancy however becomes irrelevant.

DE102016221304 describes a redundant electrical machine by way of which this problem is addressed. The machine that is proposed here has two subsystems that each comprise a rotor and a stator winding system. The rotors are seated on a common shaft and drive a propeller by way of this shaft. In the case of a fault in one of the winding systems, a situation whereby the associated rotor continues to rotate is intended to be prevented, in order to rule out induction of power into the faulty winding system. This is achieved by using freewheels that are arranged between the respective rotor and the shaft such that, in the case of a fault, the rotor of a defective subsystem of the machine is no longer driven by a common shaft. Although this solves the above-described problem, freewheels, and with them the entire system as well, are comparatively vulnerable, and the electrical machines in the proposed configuration are able to be operated only as motors but not as generators. The generator operating mode is however required, inter alia, for fast speed control, for example for quadrocopters or VTOL aircraft, and for recovery.

One object of the present invention is therefore to specify an option for improving protection against failure for an electrical machine.

This object is achieved by the redundant electrical machine described in claim 1. The dependent claims describe advantageous configurations.

The redundant electrical machine has a drive system for driving a propulsion means. The drive system for its part comprises a stator arrangement having at least two stator winding systems and a rotor arrangement having at least one rotor, wherein each rotor has at least one, but ideally a plurality of permanent magnets.

Each stator winding system is assigned one of the rotors. Of course, this also includes the case that the same rotor is assigned simultaneously to two different stator winding systems. A respective stator winding system and the rotor assigned thereto are arranged with respect to one another so as to form a respective air gap between one another. It should thus be assumed that a respective air gap exists for each stator winding system. The respective stator winding system and the permanent magnet of the rotor assigned to the respective stator winding system are able to interact electromagnetically with one another across the respective air gap during normal operation of the electrical machine, such that the electrical machine is able to operate efficiently as an electric motor or as a generator.

The electrical machine has a movement device for mutually moving the faulty stator winding system and the rotor assigned thereto out of a normal position for a case of a fault that occurs in a faulty one of the two stator winding systems. The device is designed such that, by virtue of the movement out of the normal position, the air gap between the faulty stator winding system and the rotor assigned thereto is increased, such that the efficiency of the electrical machine or of the drive subsystem is significantly reduced.

The expression “mutual movement” of a first and a second component in this case contains both the option that the first component is able to be moved with respect to the second component and the alternative that the second component is able to be moved with respect to the first component. In principle, this would also jointly comprise the third possibility that both components are able to be moved, preferably then in opposing directions.

The “normal position” in this case denotes that position of the rotor and the assigned stator that these components are in when the electrical machine runs during normal operation, that is to say in particular when no case of a fault is present. This normal position is distinguished in that the electromagnetic interaction between the permanent magnets and the stator winding system is at a maximum.

The electrical machine may in this case be designed as an axial or as a radial flux machine.

The concept underlying the invention is based on the fact that, in the case of a fault, for example in the case of a short circuit in the stator winding system, the electromagnetic interaction between permanent magnets and stator coils of this faulty stator winding system is suppressed or at least significantly reduced. In other words, the rotor is thus magnetically decoupled from the active parts of the stator. This is achieved by influencing and in particular increasing the air gap between the components that interact with one another during normal operation, accompanied by magnetic decoupling between these components. In this connection, the term “air gap” may also simply mean the distance between the components that are to be decoupled from one another. The air gap is in this case increased by virtue of at least one of the relevant components assigned to one another, that is to say the rotor or the corresponding stator winding system, being moved with respect to the respective other component, typically in the axial direction.

The term “significant” used above in connection with the electromagnetic interaction means that the electromagnetic interaction has to be reduced to the extent that a voltage induced in the faulty winding system by the possibly still rotating permanent magnets is so low that there is no risk of flashover or other situations that for example trigger a fire. Ideally, power is no longer induced in the fault site.

A “case of a fault” may be for example an excess temperature, an insulation fault or short circuit in the stator winding system or else the failure of a voltage source supplying a stator winding system. In the context of this invention, the case of a fault is intended in particular to relate to situations in which it should be avoided that a significant voltage or power is induced in the faulty stator winding system or the corresponding stator coils due to continued rotation of the rotor equipped with permanent magnets.

The expression “during normal operation” means that the electrical machine operates as intended in this state or during this operation, and in particular that no case of a fault is present.

If the electrical machine is thus operating, it is able to operate during normal operation or a case of a fault is present.

The movement device is advantageously designed such that the movement is oriented in an axial direction.

In this case, the movement device has a mechanical means and a releasable latch. In the case of a fault, the mechanical means is able to provide a force required for the movement to the faulty stator winding system and/or to the rotor assigned thereto.

The releasable latch has the effect on the mechanical means or on the component to be moved, that is to say on the stator winding systems or on the rotor, that the mechanical means exerts the force only when the case of a fault is present after the latch has been released, but not during normal operation of the electrical machine.

The mechanical means extends between two ends, wherein one of the ends is attached to a fixed point outside of the drive system, for example to a casing of the electrical machine, and the other end is attached to the stator winding system to be moved or to the rotor to be moved.

As an alternative, one of the ends may be attached to the respective stator winding system and the other end may be attached to the rotor assigned to this stator winding system.

In one exemplary embodiment, the mechanical means has at least one spring device. A rotor and at least one of the spring devices are respectively assigned to one another, wherein each rotor is mechanically connected to the spring device assigned thereto, such that the mechanical means is able to apply the force to the respective rotor. The respective spring device is preloaded in the normal position and during normal operation and set by way of the latch such that it exerts the force on the rotor assigned thereto in the case of a fault when the latch is released, wherein the force has a component in the axial direction such that the respective rotor is moved in the axial direction when the latch is released.

In particular for this case in which the respective rotor is intended to be moved, it is expedient for each rotor to be arranged on a shaft for transferring a drive power provided by the respective rotor to the propulsion means such that said rotor is able to be rotated with respect to the stator winding systems and for said rotor to be connected in a rotationally fixed manner to the shaft such that it is not able to be rotated with respect to the shaft but is able to be moved in the axial direction.

In another exemplary embodiment, the mechanical means likewise has at least one spring device, wherein a stator winding system and at least one of the spring devices are respectively assigned to one another. Each stator winding system is mechanically connected to the spring device assigned thereto, such that the mechanical means is able to apply the force to the respective stator winding system. The respective spring device is again preloaded in the normal position and during normal operation and set by way of the latch such that it exerts the force on the stator winding system assigned thereto in the case of a fault when the latch is released, wherein the force has a component in the axial direction such that the respective stator winding system is moved in the axial direction when the latch is released. The stator winding systems may for example be attached to rails by way of which they are able to be moved.

In one embodiment, the machine is designed as an axial flux machine in which the rotor is arranged between the stator winding systems as seen in the axial direction, such that a magnetic flux generated by the stator winding systems is oriented in the substantially axial direction. The movement device is designed and arranged such that it moves the faulty stator winding system in the axial direction away from the rotor in the case of a fault, such that the respective air gap between the moved faulty stator winding system and the rotor assigned thereto increases, whereas the air gap between the non-faulty stator winding system and the rotor assigned thereto remains unchanged.

In a further case in which the machine is designed as an axial flux machine, the rotor arrangement has at least one further rotor, that is to say at least two stator winding systems and two rotors are present, ideally one rotor for each stator winding system. One of the stator winding systems and one of the rotors are in each case assigned to one another so as to form a respective electrical submachine. A respective stator winding system and the rotor assigned thereto are arranged behind one another as seen in the axial direction and so as to form an air gap between one another, such that the respective stator winding system and the permanent magnet of the rotor assigned to the respective stator winding system are able to interact electromagnetically with one another across the respective air gap during normal operation of the electrical machine. The submachines are arranged far enough apart from one another as seen in the axial direction that the rotor of one submachine does not interact, that is to say interacts at most negligibly, electrically with the stator winding system of the other submachine. The movement device is designed and arranged such that it moves the faulty stator winding system and/or the rotor, assigned to the faulty stator winding system, of the thus faulty submachine away from one another in the axial direction in the case of a fault, such that the air gap of the faulty submachine increases. At the same time, the air gap between the non-faulty stator winding system and the rotor assigned thereto remains unchanged.

In another embodiment, the machine is designed as a radial flux machine. The rotor arrangement has at least one further rotor, that is to say at least two stator winding systems and two rotors are again present. One of the stator winding systems and one of the rotors are in each case assigned to one another so as to form a respective electrical submachine. A respective stator winding system and the rotor assigned thereto are arranged at a substantially identical position as seen in the axial direction in the normal position and during normal operation, such that the respective air gap is between the respective stator winding system and the rotor assigned thereto in the radial direction, such that the respective stator winding system and the permanent magnet of the rotor assigned to the respective stator winding system are able to interact electromagnetically with one another across the respective air gap during normal operation of the electrical machine. The submachines are arranged far enough apart from one another as seen in the axial direction that the rotor of one submachine does not interact, that is to say interacts at most negligibly, electrically with the stator winding system of the other submachine. The movement device is designed and arranged such that it moves the faulty stator winding system and/or the rotor, assigned to the faulty stator winding system, of the thus faulty submachine away from one another in the axial direction in the case of a fault, such that the air gap of the faulty submachine increases, whereas the air gap between the non-faulty stator winding system and the rotor assigned to this stator winding system remains unchanged.

Each of the stator winding systems has magnetically active regions, in particular stator electrical metal sheets, that each extend over a first region as seen in the axial direction. The rotor assigned to the respective stator winding system, in particular the permanent magnet thereof, likewise extends over a second region in the axial direction. A respective stator winding system and the rotor assigned thereto are arranged, in the normal position, such that one of the two regions completely comprises the respective other region, wherein the middles of the two regions are arranged at substantially the same position as seen in the axial direction. This includes the fact that the two regions are congruent as seen in the axial direction.

The movement device may in this case be designed, in a first alternative, such that the mutual movement in the case of a fault is at least such that the first region of the axial extent of the faulty stator winding system and the second region of the axial extent of the rotor assigned thereto no longer overlap after the respective rotor and/or the assigned stator winding system have been moved. This ensures that the electromagnetic interaction is as far as possible suppressed.

In a second alternative, the movement device may be designed such that the mutual movement in the case of a fault is only such that the first region of the axial extent of the faulty stator winding system and the second region of the axial extent of the rotor assigned thereto still overlap after the respective rotor and/or the assigned stator winding system have been moved, but such that one of the two regions no longer completely comprises the other region as seen in the axial direction. Although the electromagnetic interaction is suppressed to a lesser extent than in the first alternative, the machine requires less installation space and is accordingly not as heavy. The movement required to sufficiently suppress the electromagnetic interaction may be calculated in advance, such that the movement device and the electrical machine are able to be dimensioned accordingly per se. By way of example, it may be sufficient for the overlap not to be 0% as in the first alternative, but rather for example 30%. This second alternative accordingly constitutes a compromise between protection of the drive system against failure and the required installation space.

In a further embodiment of the radial flux machine, each of the rotors is formed conically such that a radius of a respective rotor is not constant, but rather changes continuously or incrementally with a height of the rotor extending in the axial direction between the axial ends of the respective rotor. Each of the stator winding systems is formed, in accordance with the conical form of the rotor assigned thereto, such that the radial extent of the respective air gap between the respective stator winding system and the rotor assigned thereto is substantially identical in the normal position at each point of the height of the respective rotor.

The rotors are arranged such that, for each rotor, the radius is at a maximum at that axial end of the respective rotor that faces the respective other rotor. The radius at the respective other end of the respective rotor is accordingly at a minimum. The same applies to the stator winding systems, that is to say, for each stator winding system, the radius is at a maximum at that axial end of the respective system that faces the respective other stator winding system.

Further advantages and embodiments become apparent from the drawings and the corresponding description.

The invention and exemplary embodiments are explained in more detail below with reference to drawings. Identical components in different figures are referenced by identical reference signs in this case.

In the figures:

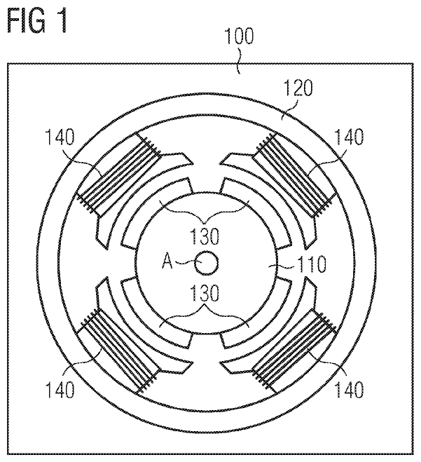

FIG. 1 shows a permanently excited electrical machine,

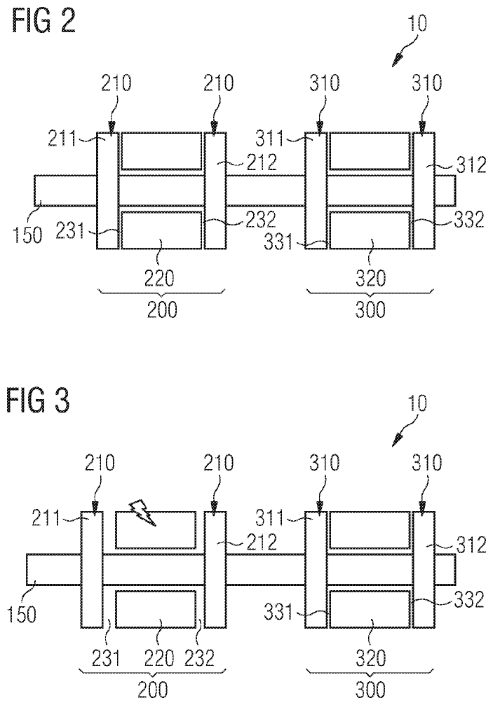

FIG. 2 shows a first variant of a first embodiment of an electrical machine during normal operation,

FIG. 3 shows the first variant of the first embodiment of the electrical machine in the case of a fault,

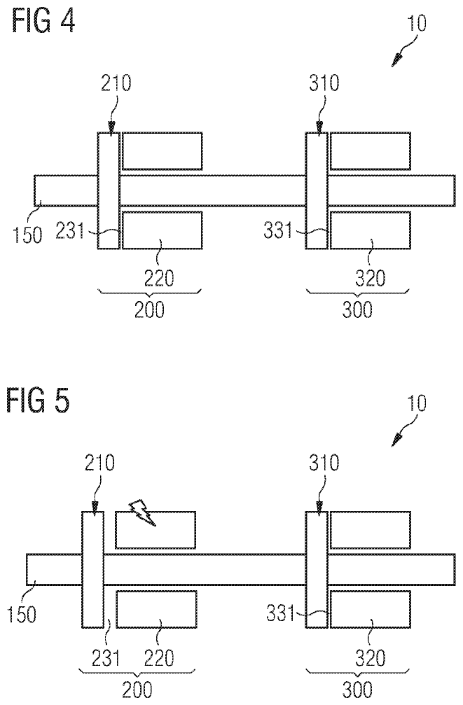

FIG. 4 shows a second variant of the first embodiment of the electrical machine during normal operation,

FIG. 5 shows the second variant of the first embodiment of the electrical machine in the case of a fault,

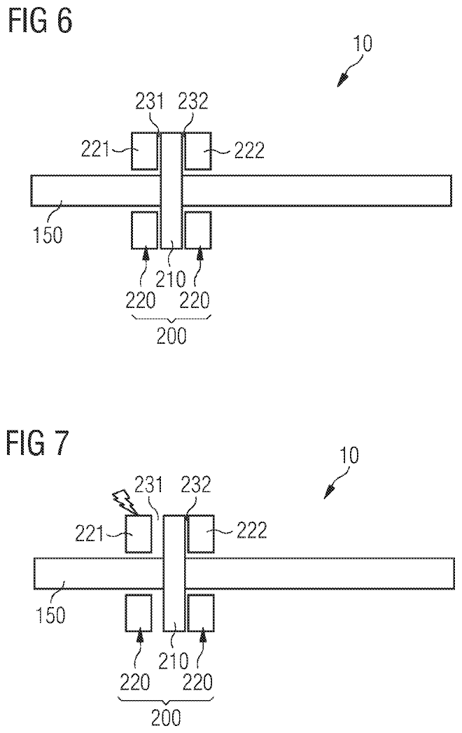

FIG. 6 shows a third variant of the first embodiment of the electrical machine during normal operation,

FIG. 7 shows the third variant of the first embodiment of the electrical machine in the case of a fault,

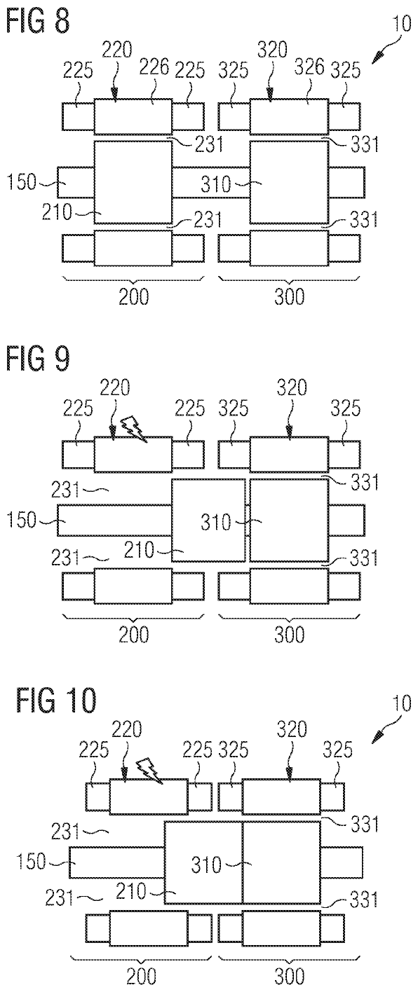

FIG. 8 shows a first variant of a second embodiment of the electrical machine during normal operation,

FIG. 9 shows the first variant of the second embodiment of the electrical machine in the presence of a case of a fault,

FIG. 10 shows a second variant of the second embodiment of the electrical machine in the presence of a case of a fault,

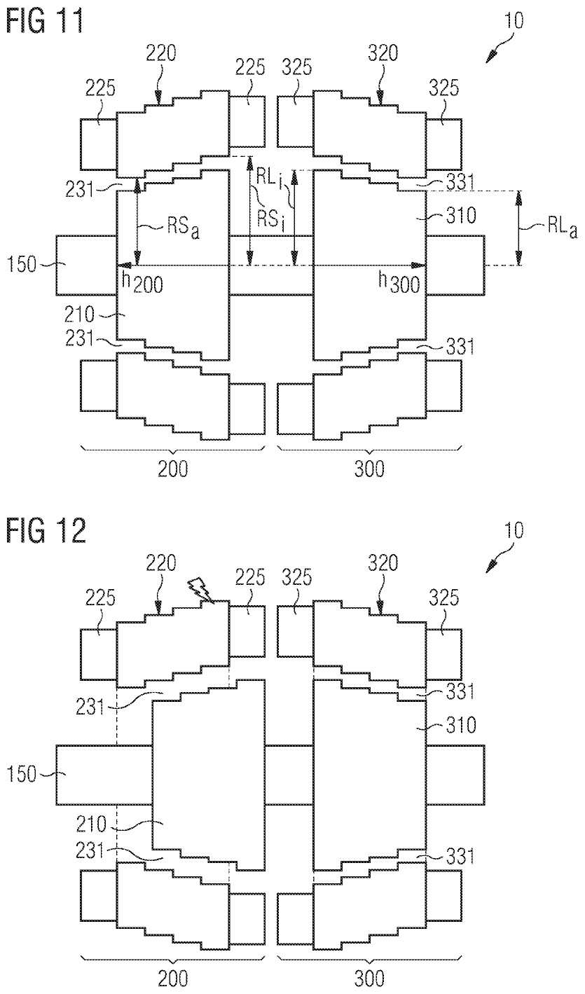

FIG. 11 shows a third variant of the second embodiment of the electrical machine during normal operation,

FIG. 12 shows the third variant of the second embodiment of the electrical machine in the presence of a case of a fault,

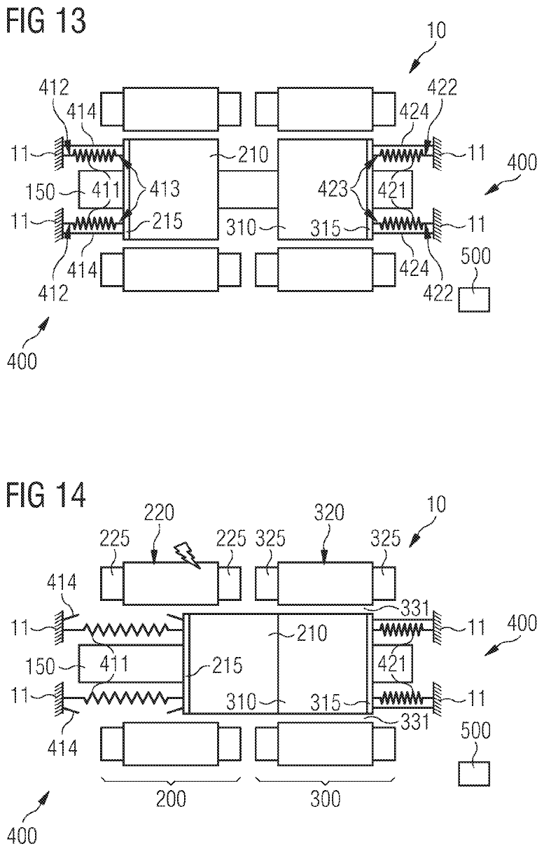

FIG. 13 shows the first variant of the second embodiment during normal operation and with a movement device,

FIG. 14 shows the first variant of the second embodiment in the presence of a case of a fault and with the movement device.

It is pointed out that terms such as “axial” and “radial” relate to the shaft or axle used in the respective figure or in the respectively described example. In other words, the directions axial and radial always relate to an axis of rotation of the respective rotor.

A component in which a case of a fault occurs is consequently referred to hereinafter as “faulty component”.

FIG. 1 shows, merely to explain the basic operation or the fundamental concept, an overview of a simple, permanently excited electrical machine 100. The machine 100 has a rotor 110 with permanent magnets 130 and a stator 120 with a stator winding system or stator coils 140. The rotor 110 attached to a shaft 150 is able to be rotated with the shaft 150 about an axis of rotation A with respect to the stator 120. In the operating state of the electrical machine 100, the rotor 110 rotates with respect to the stator 120. The rotor 110 and the stator 120 are arranged with respect to one another such that a magnetic field of the permanent magnets 130 and the coils 140 interact electromagnetically with one another such that the electrical machine 100 operates in a first operating mode as a generator and/or in a second operating mode as an electric motor due to the interaction. If the electrical machine 100 operates as a generator, then the rotor 110 and, with it, the permanent magnets 130 are set in rotation by way of the shaft 150 of the electrical machine 100, such that electric voltages are induced in the coils 140 of the stator 120, these electric voltages being able to be tapped off via electrical terminals that are not illustrated. If the electrical machine 100 is intended to operate as an electric motor and for example drive a propeller, then an electric current is applied to the coils 140 such that, due to the interaction of the magnetic fields generated thereby with the fields of the permanent magnets 130, a torque acts on the rotor 110 and therefore on the shaft 150, which torque is able to be forwarded to the device to be driven, for example the propeller.

In developments of the electrical machine 100, said electrical machine may be designed as an axial flux machine or as a radial flux machine, this however not having any influence on the basic operation that has just been described. The machine 100 may likewise have a plurality of rotors and/or a plurality of stators in order, for example, to increase redundancy, that is to say a plurality of drive subsystems, and/or the rotor or the stator may be designed as a single or dual rotor or single or dual stator. In all of these cases, the basic concept of the electrical machine however remains applicable. It is in particular the case in all cases that the efficiency of said electromagnetic interaction and thus ultimately the power density of the electrical machine depends on the extent of what is known as the air gap between the mutually interacting permanent magnets and stator coils or between mutually assigned rotor and stator. In this case, the efficiency increases as the air gap becomes smaller, that is to say an air gap that is as narrow or small as possible is beneficial during normal operation. By contrast, the efficiency drops as the air gap becomes larger, until the distance between stator and rotor is so great that the electromagnetic interaction becomes so low that virtually no voltage is induced any more in the stator coils, in spite of the rotating rotor.

Since the basic operation of an electrical machine 100 is known, a more extensive explanation is not provided at this point.

For the sake of clarity, the illustration of the permanent magnets and of the stator coils is not given in the following figures. By contrast, only rotors or stators are illustrated without further detail, it being able to be assumed that the illustrated rotors have a multiplicity of permanent magnets and the stators have a multiplicity of stator winding systems or stator coils, such that mutually assigned rotors and stators or their permanent magnets and winding systems are able to interact electromagnetically with one another in order to operate the electrical machine 10 as an electric motor or as a generator. It should furthermore be assumed in this case that, in the case that the rotor is designed as a dual rotor having two sub-rotors, the permanent magnets are arranged on the sub-rotors. In the case that the rotor is designed as a single rotor, the permanent magnets are consequently located on the single rotor. The same applies to the stator: If said stator is designed as a dual stator with two sub-stators, the stator winding systems are located on the sub-stators. In the case of a single stator, the stator winding systems are arranged on this single stator. Independently of the design of the rotor and of the stator, it is the case in all embodiments and variants that each rotor is able to be rotated with respect to the respectively associated stator. In this case, the rotors are connected in a rotationally fixed manner to the shaft, for example by way of a corresponding tooth system. All of the rotors and stators are furthermore arranged concentrically with respect to one another and to the respective shaft.

In the first embodiment, the electrical machine 10 is designed as an axial flux machine, that is to say in particular that the rotor and the stator are arranged behind one another in the axial direction and the magnetic flux runs between the rotor and the stator in the substantially axial direction.

FIG. 2 shows a first variant of the first embodiment during normal operation, in which the machine 10 has a first drive subsystem 200 and, for redundancy purposes, also has a second drive subsystem 300. Each of the drive subsystems 200, 300 comprises a dual rotor 210, 310 having sub-rotors 211, 212, respectively 311, 312 able to be moved on the shaft 150 in the axial direction, and a stator 220, 320, wherein the stators 220, 320 are each arranged between the sub-rotors 211, 212, respectively 311, 312 of the respective drive subsystem 200, 300 in the axial direction.

The first dual rotor 210 and the first stator 220 are assigned to one another and designed during normal operation of the machine 10 and arranged with respect to one another so as to form air gaps 231, 232 between one another such that they are able to interact electromagnetically with one another.

The second dual rotor 310 and the second stator 320 are likewise assigned to one another and designed during normal operation of the machine 10 and arranged with respect to one another so as to form air gaps 331, 332 between one another such that they are able to interact electromagnetically with one another.

Both the first 210 and the second dual rotor 310 or the sub-rotors 211, 212, 311, 312 are connected in a rotationally fixed manner to a shaft 150. If the drive subsystems 200, 300 operate as electric motors, the shaft 150 is driven by the dual rotors 210, 220, such that a propulsion means (not illustrated) connected to the shaft 150, for example a propeller, is able to be set in rotation.

FIG. 3 shows the first variant of the first embodiment in the presence of a case of a fault in the stator winding system of the stator 220 of the first drive subsystem 200. As is able to be clearly seen, a device 400, not yet illustrated here, has been used to achieve the effect whereby the air gaps 231, 232 between the first stator 220 and the sub-rotors 211, 212 have been increased to the extent that the electromagnetic interaction between the first stator 220 and the sub-rotors 211, 212 is suppressed, that is to say the first dual rotor 210 is magnetically decoupled from the faulty stator 220. Although the shaft 150 and, with it, the sub-rotors 211, 212 thus rotate, in particular due to the second drive subsystem 300, which continues to operate as an electric motor, on account of the increased air gaps 231, 232, no voltages are induced in the stator winding system of the first stator 220, as a result of which the risk of fire is reduced to a minimum or virtually ruled out. Furthermore, in spite of the failure of the first drive subsystem 200, the propulsion means is still able to be operated, just with reduced efficiency. Redundancy is thus provided in this variant.

FIG. 4 shows a second variant of the first embodiment during normal operation, in which the machine 10 likewise has a first 200 and, for redundancy purposes, also has a second drive subsystem 300. Each of the drive subsystems 200, 300 comprises a rotor 210, 310 able to be moved on the shaft 150 in the axial direction, in particular designed as a single rotor 210, 310, and a stator 220, 320. The second variant of the first embodiment differs from the first variant only in that the rotors 210, 310 are not designed here as dual rotors.

The rotors 210, 310 and the stators 220, 320 of the respective drive subsystem 200, 300 are also assigned to one another in this variant and designed during normal operation of the machine 10 and arranged with respect to one another so as to form air gaps 231, 331 between one another such that they are able to interact electromagnetically with one another. During normal operation, the drive subsystems 200, 300 thus operate such that they both set the shaft 150 in rotation by way of their rotor 210, 310.

FIG. 5 shows the second variant of the first embodiment in the presence of a case of a fault in the stator winding system of the stator 220 of the first drive subsystem 200. Similarly to in the first variant, the device 400, likewise not illustrated here, has been used to achieve the effect whereby the air gap 231 between the first stator 220 and the first rotor 210 has been increased to the extent that the electromagnetic interaction between the first stator 220 and the rotor 210 is suppressed, that is to say the first rotor 210 is magnetically decoupled from the faulty stator 220. It is the case here too that, on account of the increased air gap 231, no voltages are able to be induced in the stator winding system of the first stator 220, as a result of which the risk of fire is reduced to a minimum or virtually ruled out, even though, in particular due to the second drive subsystem 300, which is still operating as an electric motor, the shaft 150 and, with it, the rotor 210 rotate. Furthermore, in spite of the failure of the first drive subsystem 200, the propulsion means is still able to be operated, just with reduced efficiency. Redundancy is thus also provided in this variant.

FIG. 6 shows a third variant of the first embodiment of the electrical machine 10 during normal operation. The machine 10 has a drive system 200 that is already redundant in and of itself, comprising a rotor 210, in particular a single rotor, and a dual stator 220 having sub-stators 221, 222 able to be moved on the shaft 150 in the axial direction. The rotor 210 is arranged between the sub-stators 221, 222 in the axial direction.

The rotor 210 and the stator 220 of the drive system 200 are also assigned to one another in this third variant of the first embodiment and designed during normal operation of the machine 10 and arranged with respect to one another so as to form air gaps 231, 331 between one another such that they are able to interact electromagnetically with one another. During normal operation, the drive system 200 thus operates such that it sets the shaft 150 in rotation by way of the rotor 210.

FIG. 7 shows the third variant of the first embodiment in the presence of a case of a fault in the stator winding system of the sub-stator 221. In this case too, the device 400, likewise not illustrated here, has been used to achieve the effect whereby the air gap 231 between the sub-stator 221 and the rotor 210 has been increased to the extent that the electromagnetic interaction between the sub-stator 221 and the rotor 210 is suppressed, that is to say the rotor 210 is magnetically decoupled from the faulty first sub-stator 221. Due to the larger air gap 231, no voltages are able to be induced in the stator winding system of the sub-stator 221, even though the rotor 210 continues to rotate due to its interaction with the intact sub-stator 222. Due to this rotation, the shaft 150 and, with it, the propulsion means is driven, even in spite of the case of a fault in the sub-stator 221, again just with reduced efficiency. Redundancy is thus also provided in this variant.

The following FIGS. 8 to 12 relate to a second embodiment of the electrical machine 10. In the variants of the second embodiment, the machine 10 is designed as a radial flux machine, that is to say in particular that a rotor and a stator that are assigned to one another and interact with one another during normal operation are arranged at substantially the same position in the axial direction, but that the stator is arranged radially outside the rotor (also vice versa in theory). The magnetic flux between the rotor and the stator runs in the substantially radial direction.

In the figures with regard to the variants of the second embodiment, the winding heads 225, 325 that are typically present are also illustrated for the respective stators 220, 320. The stators 220, 320 furthermore each have stator electrical metal sheets 226, 326. Due to the space required by the winding heads 225, 325, there is a space, in the axial direction between the stator electrical metal sheets 226, 326 of the two stators 220, 320, in which no electrical metal sheet is present. As shown below, this space is required in order to move a respective rotor 210, 310.

FIG. 8 shows a first variant of the second embodiment during normal operation. The machine 10 has a first drive subsystem 200 and, for redundancy purposes, also has a second drive subsystem 300. Each of the drive subsystems 200, 300 comprises a rotor 210, 310 able to be moved on the shaft 150 in the axial direction and a stator 220, 320.

The first rotor 210 and the first stator 220 are assigned to one another and designed during normal operation of the machine 10 and arranged with respect to one another so as to form an annular or cylindrical air gap 231 between one another such that they are able to interact electromagnetically with one another.

The second rotor 310 and the second stator 320 are likewise assigned to one another and designed during normal operation of the machine 10 and arranged with respect to one another so as to form an annular or cylindrical air gap 331 between one another such that they are able to interact electromagnetically with one another.

If the drive subsystems 200, 300 operate as electric motors, the shaft 150 is driven by the rotors 210, 220 such that a propulsion means (not illustrated) connected to the shaft 150, for example a propeller, is able to be set in rotation.

FIG. 9 shows the first variant of the second embodiment in the presence of a case of a fault in the stator winding system of the stator 220 of the first drive subsystem 200. As is able to be clearly seen, the device 400, not illustrated here, has been used to achieve the effect whereby the rotor 210 assigned to the faulty stator 220 has been moved in the axial direction. In this first variant of the second embodiment, the rotor 210 is in particular moved to the extent that it moves out of the region within the stator electrical metal sheet 226 into the region underneath the winding heads 225, 325. The movement has the effect that the air gap 231 or the distance between the faulty stator 220 and the rotor 210 has increased to the extent that the electromagnetic interaction between the first stator 220 and the rotor 210 is suppressed, that is to say the first rotor 210 is magnetically decoupled from the faulty stator 220. Although the shaft 150 and, with it, the rotor 210 thus rotate, in particular due to the second drive subsystem 300, which continues to operate as an electric motor, on account of the increased air gap 231 or distance, no voltages are induced in the stator winding system of the first stator 220, as a result of which the risk of fire is reduced to a minimum or virtually ruled out. Furthermore, in spite of the failure of the first drive subsystem 200, the propulsion means is still able to be operated, just with reduced efficiency. Redundancy is thus provided in this variant.

In this first variant of the second embodiment, and likewise in the second variant to be described below, the air gap is strictly speaking not only increased, but rather the original geometry of the air gap is lost. In spite of this, reference is also made to an “increase” in the air gap in this connection, this in particular however meaning, in connection with the radial flux machine, that the distance between the rotor and the assigned stator is increased. Independently of the terminology, it should be assumed that the loss of the geometry of the air gap, in addition to the pure increase in the distance, has an essential influence on reducing the electromagnetic interaction.

FIG. 10 shows a second variant of the second embodiment that corresponds to the first variant of the second embodiment apart from the detail that, in the second variant, the space into which the rotor 210, 310 is able to be moved in the case of a fault has a smaller extent in the axial direction. This may for example be due to restricted spatial conditions. Due to the similarity between the variants, no explanation is given of this second variant for normal operation. FIG. 10 therefore shows the second variant of the second embodiment in the presence of a case of a fault in the stator winding system of the stator 220 of the first drive subsystem 200. The assigned rotor 210 has been moved in the axial direction. In this second variant of the second embodiment, the rotor 210 is however only moved to the extent that it still protrudes partly into the region within the stator electrical metal sheet 226. In this case, although the electromagnetic interaction between the rotor 210 and the stator 220 is still greater than in the first variant, it is possible to assume cases in which it is actually not necessary to completely remove the rotor 210 from said region. In this case, the abovementioned topic also continues to play a role in that the geometry of the air gap 231 is also changed greatly in the first and second variant.

The movement thus has the effect that the air gap 231 or the distance between the faulty stator 220 and the rotor 210 has increased to the extent that the electromagnetic interaction between the first stator 220 and the sub-rotors 211, 212 has been reduced to a sufficient extent, that is to say the first rotor 210 is magnetically decoupled from the faulty stator 220. Although the shaft 150 and, with it, the rotor 210 thus rotate, in particular due to the second drive subsystem 300, which continues to operate as an electric motor, on account of the increased air gap 231 or distance, no voltages are induced in the stator winding system of the first stator 220, as a result of which the risk of fire is reduced to a minimum or virtually ruled out. Furthermore, in spite of the failure of the first drive subsystem 200, the propulsion means is still able to be operated, just with reduced efficiency. Redundancy is thus provided in this variant.

FIG. 11 shows a third variant of the second embodiment during normal operation. The machine 10 has a first drive subsystem 200 and, for redundancy purposes, also has a second drive subsystem 300. Each of the drive subsystems 200, 300 comprises a rotor 210, 310 able to be moved on the shaft 150 in the axial direction and a stator 220, 320.

The first rotor 210 and the first stator 220 are assigned to one another and designed during normal operation of the machine 10 and arranged with respect to one another so as to form an air gap 231 between one another such that they are able to interact electromagnetically with one another.

The second rotor 310 and the second stator 320 are likewise assigned to one another and designed during normal operation of the machine 10 and arranged with respect to one another so as to form an air gap 331 between one another such that they are able to interact electromagnetically with one another.

If the drive subsystems 200, 300 operate as electric motors, the shaft 150 is driven by the rotors 210, 220 such that a propulsion means (not illustrated) connected to the shaft 150, for example a propeller, is able to be set in rotation.

Unlike the other variants of the second and also the first embodiment, the rotors 210, 310 in the third variant are not substantially cylindrical, but rather they have a conical form. The rotors 210, 310 are thus distinguished in that their radii RL are not constant, but rather change with the height of the respective rotor 210, 310, the height extending in the axial direction. The form of the rotors 210, 310 is in particular such that the radius RLi is at a maximum on that side of the respective rotor 210, 310 that faces the respective other rotor 310, 210. The radius RLa is accordingly at a minimum on the respective other side of the respective rotor 210, 310. In the region between the two ends of the respective rotor 210, 310, the radius RL from one to the other side of the respective rotor 210, 310 changes continuously or else, as illustrated in FIG. 11, incrementally.

The stators 220, 320 are formed, in accordance with the conical form of the rotors 210, 310, such that the radial extent of the air gaps 231, 331 is identical everywhere, that is to say at each point of the height of the respective rotor 210, 310, in particular during normal operation. The stators 220, 320 designed as hollow bodies in the embodiments illustrated here are also accordingly distinguished in that their inner radii RS are not constant, but rather change with the height of the respective stator 220, 320. In this case, the heights of the stators 220, 320 also extend in the axial direction. The form of the stators 220, 320 is in particular such that the inner radius RSi is at a maximum on that side of the respective stator 220, 320 that faces the respective other stator 320, 220. The inner radius RSa is accordingly at a minimum on the respective other side of the respective stator 220, 320. In the region between the two ends of the respective stator 220, 320, the inner radius RS from one to the other side of the respective stator 220, 320 changes continuously or else, as illustrated in FIG. 11, incrementally. The stators 220, 320 are thus formed such that they have a form matching the conical form of the respectively assigned rotor 210, 310, in particular on their inner side, that is to say are likewise conical.

The above description applies in particular to the illustrated case in which the rotors 210, 310 are designed as internal rotors. In one alternative design that is however not illustrated and in which the rotors are designed as external rotors, the arrangement would be the same as the arrangement illustrated in FIG. 11, but in this case the rotors would be designed as hollow bodies and their inner radii would be accordingly matched to the conical form of the radially inner stator such that the respective air gap is constant.

During normal operation, it is accordingly the case for both drive subsystems 200, 300 that: RS(h)=RL(h)+L, wherein “h” indicates the position in the axial direction and L describes the extent of the air gap 231, 331 in the radial direction.

FIG. 12 shows the third variant of the second embodiment in the presence of a case of a fault in the stator winding system of the stator 220 of the first drive subsystem 200. As is able to be clearly seen, the device 400, not illustrated here, has been used to achieve the effect whereby the assigned rotor 210 has been moved in the axial direction such that, on account of the conical form of the rotor 210 and of the stator 220, the air gap 231 increases such that the electromagnetic interaction between the first stator 220 and the rotor 210 is suppressed, that is to say the first rotor 210 is magnetically decoupled from the faulty stator 220. Although the shaft 150 and, with it, the rotor 210 thus rotate, in particular due to the second drive subsystem 300, which continues to operate as an electric motor, on account of the increased air gap 231 or distance, no voltages are induced in the stator winding system of the first stator 220, as a result of which the risk of fire is reduced to a minimum or virtually ruled out. Furthermore, in spite of the failure of the first drive subsystem 200, the propulsion means is still able to be operated, just with reduced efficiency. Redundancy is thus provided in this variant.

The particular advantage of the third variant with conical rotors 210, 310 and accordingly formed stators 220, 320 is that the respective rotor 210, 310 has to be moved to a significantly lesser extent in order to significantly increase the respective air gap 231, 331 in the case of a fault. That is to say, the geometry proposed in the third variant is advantageous in particular in the case of constricted spatial conditions.

In the embodiments or variants in which a plurality of stators or sub-stators are provided, it should be assumed that the individual stators or sub-stators are electrically insulated such that a fault in one stator or sub-stator is not able to propagate to the respective other stator or sub-stator.

FIG. 13 shows, with reference to the example of the first variant of the second embodiment during normal operation, a device 400 by way of which the rotor 210, 310 are able to be moved in the axial direction. For each rotor 210, 310, the device 400 has a mechanical means 411, 421, for example mechanical springs, by way of which a respective force is able to be applied to the rotors 210, 310 to be moved. The springs 411, 421 are attached, at one end 412, 422, for example to a casing part 11 of the electrical machine 10. As an alternative, the ends 412, 422 could be attached to another fixed object, for example to the winding heads 225, 325. The respective other end 413, 423 of the springs 411, 421 is attached to the respective rotor 210, 310, preferably to a component 215, 315 of the respective rotor 210, 310 that does not jointly rotate, but rather remains stationary with respect to the casing 11. The springs 411, 421 are in this case arranged and oriented such that they are each able to exert a force that has at least one component in the axial direction, such that the respective rotor 210, 310 is possibly able to be moved on account of the force. For this purpose, the springs 411, 421 are in particular preloaded during normal operation, but the mechanical latches 414, 424 have the effect that the springs 411, 421 are prevented from relaxing and exerting the energy stored or force retained on account of the preloading. The latches may be installed at a wide variety of locations depending on the design and arrangement of the springs 411, 421. By way of example, as indicated in FIG. 13, they may create fixed connections between the casing 11 and the component 215, 315. As an alternative, the latches could also be designed for example as trigger pins.

In the case of a fault, the respective mechanical means 411 or 421, that is to say the corresponding springs 411, 421, are activated by releasing the respective latch 414, 424, such that the corresponding springs 411, 421 relax and are able to exert the force on the respective rotor 210, 310, such that said rotor is moved.

FIG. 14 shows, with reference to the example of the first variant of the second embodiment, the device 400 in the case of a fault. The latches 414 are released such that the springs 411 are able to relax, resulting in a force on the rotor 210. This has accordingly been moved, as illustrated in FIG. 14 and as already explained in connection with FIG. 10.

The latches may be released for example by a controller 500 that monitors the drive subsystems 200, 300 at least with regard to the occurrence of a case of a fault and initiates releasing of the corresponding latch 414 or 424 upon detecting such a situation.

The device 400 described in connection with FIGS. 13 and 14 and in particular the mechanical means 411, 421 may of course be implemented in a wide variety of designs, the described spring being one possible design from among said designs. This has been explained above in a configuration as a compression spring, but it may also of course be configured as a tension spring in a corresponding arrangement. Other implementations of the mechanical means 411, 421 are likewise conceivable;

pneumatic devices which, when activated, exert the required force for moving the respective rotor 210, 310 or possibly stator 220, 320, may for example be provided.

In order to ensure safety, an electrical machine has to be able to be switched off safely, including when the rotor continues to be rotated by external influences. In order to ensure reliability, however, a plurality of electrical machines have to be integrated into a mechanical chain, and all of the machines have to be able to be switched off safely, including when the rotor continues to be rotated by the remaining machines. This apparent conflict is solved by the approach proposed here.

The proposed solution accordingly makes it possible to efficiently use the redundancy of the electrical machine 10 even with a plurality of stator winding systems by preventing the undesired input of energy into a defective winding system by magnetically decoupling the associated rotor part, which leads to a reduction in the probability of occurrence of fire in the electrical machine.

For those embodiments and variants in which the machine is designed as a radial flux machine, it has been assumed merely by way of example that the rotor arrangement is equipped with internal rotors 210, 310. It should however be assumed that the same principle of movement in order to increase the respective air gap is also able to be implemented with electrical machines that operate with external rotors.

1. A redundant electrical machine for driving a propulsion means, having a drive system, wherein the drive system has
a stator arrangement having at least two stator winding systems,
rotor arrangement having at least one rotor, wherein each rotor has at least one permanent magnet, and
wherein
each stator winding system is assigned one of the rotors, wherein a respective stator winding system and the rotor assigned thereto are arranged with respect to one another so as to form a respective air gap between one another, such that the respective stator winding system and the permanent magnet of the rotor assigned to the respective stator winding system are able to interact electromagnetically with one another across the respective air gap during normal operation of the electrical machine,
and wherein
the electrical machine has a movement device for mutually moving the faulty stator winding system and the rotor assigned thereto out of a normal position for a case of a fault that occurs in a faulty one of the two stator winding systems, wherein the movement device is designed such that, by virtue of the movement out of the normal position, the air gap between the faulty stator winding system and the rotor assigned thereto is increased.

2. The redundant electrical machine as claimed in claim 1, wherein the movement device is designed such that the movement is oriented in an axial direction.

3. The redundant electrical machine as claimed in claim 1, wherein the movement device has:
a mechanical means, by way of which a force required for the movement is able to be provided to the faulty stator winding system and/or to the rotor assigned thereto in the case of a fault,
a releasable latch that has the effect that the mechanical means exerts the force only when the case of a fault is present after the latch has been released, but not during normal operation of the electrical machine.

4. The redundant electrical machine as claimed in claim 3, wherein the mechanical means extends between two ends, wherein one of the ends is attached to a fixed point outside of the drive system and the other end is attached to the stator winding system to be moved or to the rotor to be moved.

5. The redundant electrical machine as claimed in claim 3, wherein the mechanical means extends between two ends, wherein one of the ends is attached to the respective stator winding system and the other end is attached to the rotor assigned to this stator winding system.

6. The redundant electrical machine as claimed in claim 3, wherein the mechanical means has at least one spring device, wherein a rotor and at least one of the spring devices are respectively assigned to one another, wherein
each rotor is mechanically connected to the spring device assigned thereto, such that the mechanical means is able to apply the force to the respective rotor,
the respective spring device is preloaded in the normal position and during normal operation and set by way of the latch such that it exerts the force on the rotor assigned thereto in the case of a fault when the latch is released, wherein the force has a component in the axial direction such that the respective rotor is moved in the axial direction when the latch is released.

7. The redundant electrical machine as claimed in claim 1, wherein a shaft is provided for transferring a drive power provided by the respective rotor to the propulsion means, wherein each of the rotors
is able to be rotated with respect to the stator winding systems,
is connected in a rotationally fixed manner to the shaft such that it is able to be moved in the axial direction with respect to the shaft.

8. The redundant electrical machine as claimed in claim 3, wherein the mechanical means has at least one spring device, wherein a stator winding system and at least one of the spring devices are respectively assigned to one another, wherein
each stator winding system is mechanically connected to the spring device assigned thereto, such that the mechanical means is able to apply the force to the respective stator winding system,
the respective spring device is preloaded in the normal position and during normal operation and set by way of the latch such that it exerts the force on the stator winding system assigned thereto in the case of a fault when the latch is released, wherein the force has a component in the axial direction such that the respective stator winding system is moved in the axial direction when the latch is released.

9. The redundant electrical machine as claimed in claim 1, wherein the machine is an axial flux machine in which the rotor is arranged between the stator winding systems as seen in the axial direction, wherein the movement device is designed and arranged such that it moves the faulty stator winding system in the axial direction away from the rotor in the case of a fault, such that the respective air gap between the moved faulty stator winding system and the rotor assigned thereto increases, whereas the air gap between the non-faulty stator winding system and the rotor assigned thereto remains unchanged.

10. The redundant electrical machine as claimed in claim 1, wherein the machine is an axial flux machine, wherein the rotor arrangement has at least one further rotor, wherein
one of the stator winding systems and one of the rotors are in each case assigned to one another so as to form a respective electrical submachine,
a respective stator winding system and the rotor assigned thereto are arranged behind one another as seen in the axial direction and so as to form an air gap between one another,
the submachines are arranged far enough apart from one another as seen in the axial direction that the rotor of one submachine does not interact electrically with the stator winding system of the respective other submachine,
wherein
the movement device is designed and arranged such that it moves the faulty stator winding system and/or the rotor, assigned thereto, of the faulty submachine away from one another in the axial direction in the case of a fault, such that the air gap of the faulty submachine increases, whereas the air gap between the non-faulty stator winding system and the rotor assigned to this stator winding system remains unchanged.

11. The redundant electrical machine as claimed in claim 1, wherein the machine is a radial flux machine, wherein the rotor arrangement has at least one further rotor, wherein
one of the stator winding systems and one of the rotors are in each case assigned to one another so as to form a respective electrical submachine,
a respective stator winding system and the rotor assigned thereto are arranged at a substantially identical position as seen in the axial direction in the normal position, such that the respective air gap is between the respective stator winding system and the rotor assigned thereto in the radial direction,
the submachines are arranged far enough apart from one another as seen in the axial direction that the rotor of one submachine does not interact electrically with the stator winding system of the respective other submachine,
wherein
the movement device is designed and arranged such that it moves the faulty stator winding system and/or the rotor, assigned thereto, of the faulty submachine away from one another in the axial direction in the case of a fault, such that the air gap of the faulty submachine increases, whereas the air gap between the non-faulty stator winding system and the rotor assigned to this stator winding system remains unchanged.

12. The redundant electrical machine as claimed in claim 11, wherein each of the stator winding systems has magnetically active regions, in particular stator electrical metal sheets, that each extend over a first region as seen in the axial direction, wherein the rotor assigned to the respective stator winding system, in particular the permanent magnet thereof, extends over a second region in the axial direction, wherein
a respective stator winding system and the rotor assigned thereto are arranged in the normal position such that one of the two regions completely comprises the respective other region,
the movement device is designed such that the mutual movement in the case of a fault is at least such that the first region of the axial extent of the faulty stator winding system and the second region of the axial extent of the rotor assigned thereto no longer overlap after the movement.

13. The redundant electrical machine as claimed in claim 11, wherein each of the stator winding systems has magnetically active regions, in particular stator electrical metal sheets, that each extend over a first region as seen in the axial direction, wherein the rotor assigned to the respective stator winding system, in particular the permanent magnet thereof, extends over a second region in the axial direction, wherein
a respective stator winding system and the rotor assigned thereto are arranged in the normal position such that one of the two regions completely comprises the respective other region,
the movement device is designed such that the mutual movement in the case of a fault is only such that the first region of the axial extent of the faulty stator winding system and the second region of the axial extent of the rotor assigned thereto still overlap after the movement, but one of the two regions no longer completely comprises the other region as seen in the axial direction.

14. The redundant electrical machine as claimed in claim 11, wherein
each of the rotors is formed conically such that a radius of a respective rotor changes continuously or incrementally with a height of the rotor extending in the axial direction between the axial ends of the respective rotor,
each of the stator winding systems is formed, in accordance with the conical form of the rotor assigned thereto, such that the radial extent of the respective air gap between the respective stator winding system and the rotor assigned thereto is substantially identical in the normal position at each point of the height of the respective rotor.

15. The redundant electrical machine as claimed in claim 14, wherein, for each rotor, the radius is at a maximum at that axial end of the respective rotor that faces the respective other rotor.
